(19) United States
(12) Patent Application Publication
(10) Pub. No.: US 2015/0170420 A1
(43) Pub. Date: Jun. 18, 2015

(54) APPARATUS AND METHOD FOR DISPLAYING AUGMENTED REALITY

(71) Applicant: INTELLECTUAL DISCOVERY CO., LTD., Seoul (KR)

(72) Inventors: Yang Keun Ahn, Seoul (KR); Kwang Mo Jung, Seoul (KR)

(73) Assignee: INTELLECTUAL DISCOVERY CO., LTD., Seoul (KR)

(21) Appl. No.: 14/411,689

(22) PCT Filed: Jul. 1, 2013
(86) PCT No.: PCT/KR2013/005815

§ 371 Date: Dec. 29, 2014

(30) Foreign Application Priority Data
Jun. 29, 2012 (KR) 10-2012-0070759

(51) Int. Cl. G06T 19/00; G06F 3/01

(52) U.S. Cl. CPC G06T 19/006; G06F 3/013; G06F 3/017

(57) ABSTRACT

Disclosed is an apparatus for displaying an augmented reality. The disclosed apparatus for displaying an augmented reality uses a transparent display device and displays information on an object seen through the transparent display device thereon. The apparatus for displaying an augmented reality can identify the object seen through the transparent display device by recognizing the direction of a user's gaze or hand.

### TECHNICAL FIELD

Embodiments of the present invention relate to an apparatus and method for displaying an augmented reality, and more particularly, to an apparatus and method for displaying an augmented reality that uses a transparent display device configured to display information on a specific position by recognizing a gaze of a user, a direction of a hand of the user, and the like.

### BACKGROUND ART

With the development of information and communication technology, an augmented reality technique that displays virtual reality data on an object in an actual reality in real time has been suggested.

A method of determining an object of which virtual reality data is to be displayed in an augmented reality includes an augmented reality technique that displays a marker in an actual reality, recognizes the marker, and displays virtual reality data on the marker, and a markerless augmented reality technique that displays virtual reality data by directly recognizing an object in an actual reality, without displaying a marker in the actual reality.

Further, a method of displaying virtual reality data in an actual reality in an augmented reality technique includes a method of recognizing an object in a marker/markerless manner from an actual reality photographed through a camera and stored in a storage medium, and displaying virtual reality data on the recognized object, and a method of recognizing an object in a marker/markerless manner from an actual reality photographed through a camera in real time, and displaying virtual reality data on the recognized object.

### DISCLOSURE OF INVENTION

### Technical Goals

An aspect of the present invention provides technology that may intuitively provide a user with information on an object viewed by the user through a transparent display device.

### Technical Solutions

According to an aspect of the present invention, there is provided an apparatus for displaying an augmented reality, the apparatus including a recognizer configured to recognize a gaze of a user or a direction of a hand of the user positioned in a direction of a first plane of a transparent display device provided in a form of a flat plate, an object identifier configured to identify an object positioned in a direction of a second plane of the transparent display device, the object corresponding to the gaze of the user or the direction of the hand of the user, an information collector configured to collect information on the identified object, and a display unit configured to display the collected information on the display device.

The apparatus may further include a camera unit configured to generate an image by photographing the user, and the recognizer may be configured to recognize the gaze of the user or the direction of the hand of the user by analyzing the generated image.

The recognizer may be configured to recognize the user by analyzing the generated image, and the information collector may be configured to collect the information by referring to information on the recognized user.

The display unit may be configured to display the collected information at a point at which a straight line connecting the object and the gaze of the user intersects the transparent display device, or to display the collected information at a point at which a straight line connecting the object and the direction of the hand of the user intersects the transparent display device.

The display device may be configured to display second information for a second user in an area in which the information is displayed.

The display device may be configured to display the information and the second information in the same area using a lenticular lens or a polarized screen.

According to another aspect of the present invention, there is also provided a method of displaying an augmented reality, the method including recognizing a gaze of a user or a direction of a hand of the user positioned in a direction of a first plane of a transparent display device provided in a form of a flat plate, identifying an object positioned in a direction of a second plane of the transparent display device, the object corresponding to the gaze of the user or the direction of the hand of the user, collecting information on the identified object, and displaying the collected information on the display device.

The method may further include generating an image by photographing the user, and the recognizing may include recognizing the gaze of the user or the direction of the hand of the user by analyzing the generated image.

The recognizing may include recognizing the user by analyzing the generated image, and the collecting may include collecting the information by referring to information on the recognized user.

The displaying may include displaying the collected information at a point at which a straight line connecting the object and the gaze of the user intersects the transparent display device, or displaying the collected information at a point at which a straight line connecting the object and the direction of the hand of the user intersects the transparent display device.

The displaying may include displaying second information for a second user in an area in which the information is displayed.

The display device may be configured to display the information and the second information in the same area using a lenticular lens or a polarized screen.

### Advantageous Effect of the Invention

According to the following embodiments, information on an object viewed by a user through a transparent display device may be intuitively provided to the user.

### BRIEF DESCRIPTION OF DRAWINGS

FIGS. 1A and 1B are views illustrating a concept of an apparatus for displaying an augmented reality using a transparent display device according to an embodiment.

FIG. 2 is a block diagram illustrating a configuration of an apparatus for displaying an augmented reality according to an embodiment.

FIG. 3 is a view illustrating an example of displaying items of information for different users in the same area according to an embodiment.

FIGS. 4A and 4B are views illustrating transparent display devices using a polarized screen and a lenticular lens, respectively, according to an embodiment.

FIG. 5 is a flowchart illustrating a method of displaying an augmented reality according to an embodiment.

### BEST MODE FOR CARRYING OUT THE INVENTION

Reference will now be made in detail to embodiments of the present invention with reference to the accompanying drawings.

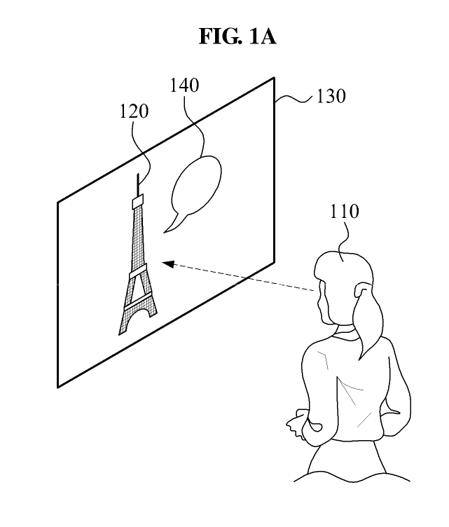

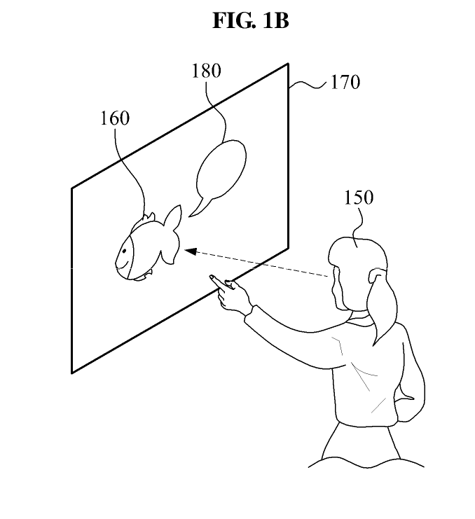

FIGS. 1A and 1B are views illustrating a concept of an apparatus for displaying an augmented reality using a transparent display device according to an embodiment.

FIG. 1A illustrates a case in which a transparent display device 130 is used as a window of a city tour bus or train. In FIG. 1A, a user 110 may be on the city tour bus or train, and view outside through the window for which the transparent display device 130 is used. When the user 110 views a tower 120 through the transparent display device 130, the apparatus for displaying an augmented reality may control information 140 on the tower 120 to be displayed in a specific area of the transparent display device 130.

In this example, the information 140 displayed on the transparent display device 130 may be information on a history of the tower 120, a location of the tower 120, or tour information on a periphery of the tower 120.

The apparatus for displaying an augmented reality may photograph the user 110 using a camera. The apparatus for displaying an augmented reality may recognize a gaze of the user 110 by analyzing the photographed image, and identify an object viewed by the user 110, in this example, the tower 120. The apparatus for displaying an augmented reality may collect information on the identified object 120, and display the collected information in the specific area of the transparent display device 130.

The area in which the collected information is displayed may include a point at which a straight line connecting the object 120 viewed by the user 110 and the gaze of the user 110 intersects the transparent display device 130.

FIG. 1B illustrates a case in which a transparent display device 170 is used as a portion of a water tank in an aquarium. In FIG. 1B, a user 150 may raise a hand and indicate a fish 160 in the water tank. In this example, the apparatus for displaying an augmented reality may control information 180 on the fish 160 to be displayed in a specific area of the transparent display device 170.

In this example, the information 180 displayed on the transparent display device 170 may include information on an ecology, fishing, and cooking of the fish 160.

The apparatus for displaying an augmented reality may photograph the user 150 using a camera. The apparatus for displaying an augmented reality may recognize a direction of the hand of the user 150, and identify an object indicated by the hand of the user 150, in this example, the fish 160. The apparatus for displaying an augmented reality may collect information on the identified object 160, and display the collected information in the specific area of the display device 170.

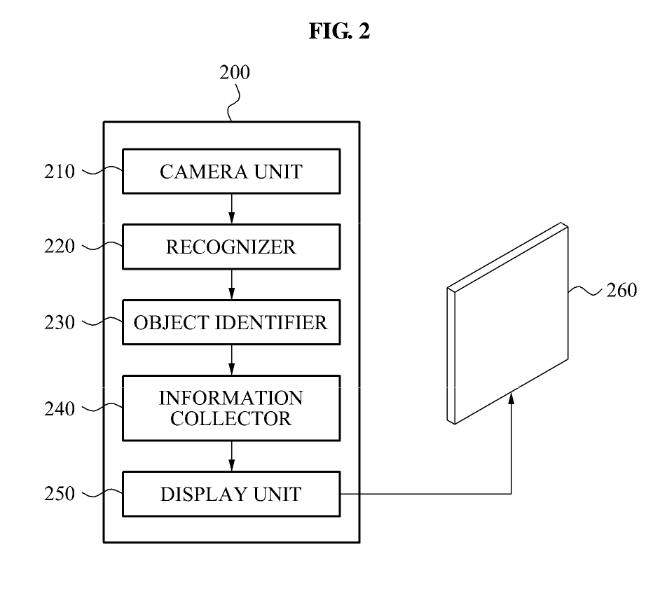

FIG. 2 is a block diagram illustrating a configuration of an apparatus for displaying an augmented reality according to an embodiment.

An apparatus 200 for displaying an augmented reality may include a camera unit 210, a recognizer 220, an object identifier 230, an information collector 240, and a display unit 250.

The camera unit 210 may generate an image by photographing a user. Here, the user may be positioned in a direction of a first plane of a transparent display device 260 provided in a form of a flat plate. The transparent display device 260 may be used as a window of a city tour bus or train. In this example, the first plane may correspond to a direction toward an inside of the city tour bus or train, and a second plane may correspond to a direction toward an outside of the city tour bus or train.

The recognizer 220 may recognize a gaze of the user or a direction of a hand of the user. The recognizer 220 may recognize the gaze of the user or the direction of the hand of the user by analyzing the image photographed by the camera unit 210.

The object identifier 230 may identify an object positioned in a direction of the second plane of the transparent display device 260, the object corresponding to the gaze of the user or the direction of the hand of the user.

For example, the transparent display device 260 may be used as a window of a city tour bus or train. In this example, the user positioned in the direction of the first plane toward the inside of the city tour bus or train may view a tower positioned in a direction of the second plane toward the outside of the city tour bus or train, or raise the hand and indicate the tower. In this example, the object identifier 230 may identify the tower viewed or indicated by the user as an object.

The information collector 240 may collect information on the identified object. The recognizer 220 may recognize the user by analyzing the image photographed by the camera unit 210, and the information collector 240 may collect the information on the identified object by referring to information on the recognized user.

For example, when the recognized user is a kid and the identified object is a building of a city, the information collector 240 may retrieve tour information, and restaurant information related to the building or a periphery of the building. However, when the recognized user is an adult and the identified object is a building of a city, the information collector 240 may retrieve real estate information of the building.

The display unit 250 may display the collected information on the display device 260. The display unit 250 may display the collected information at a point at which a straight line connecting the identified object and the gaze of the user intersects the transparent display device 260, on the transparent display device 260. The display unit 250 may display the collected information at a point at which a straight line connecting the identified object and the direction of the hand of the user intersects the transparent display device 260, on the transparent display device 260.

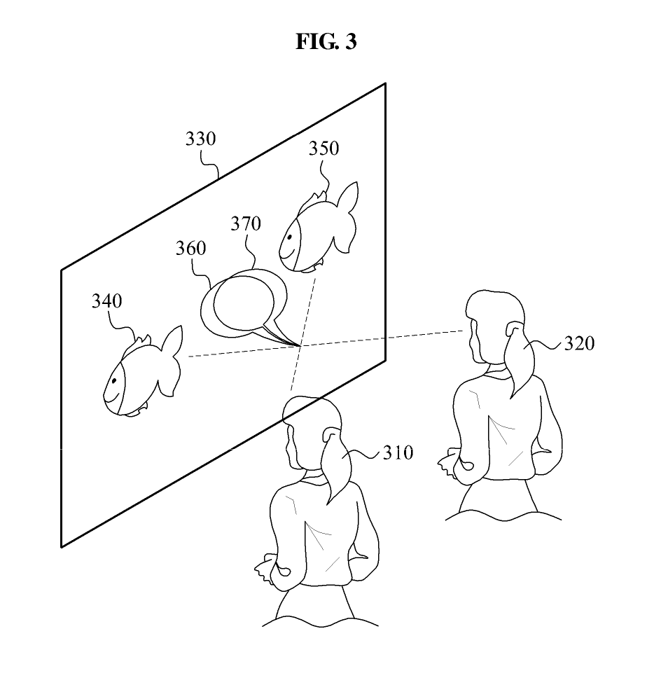

The display device 260 may display a plurality of items of information in the same area. A configuration in which a plurality of items of information are displayed in the same area will be described with reference to FIG. 3.

FIG. 3 is a view illustrating an example of displaying items of information for different users in the same area according to an embodiment.

In FIG. 3, a first user 310 views a first object 350 through a transparent display device 330, and a second user 320 views a second object 340 through the transparent display device 330.

When the plurality of users 310 and 320 view different objects 350 and 370 respectively, gazes of the respective users 310 and 320 and the transparent display device 330 may overlap in the same area. Thus, items of information on the respective objects 340 and 350 are to be displayed in the same area.

In the case of FIG. 3, the display device 330 may display first information 360 on the first object 350 and second information 370 on the second object 340 in the same area using a lenticular lens or a polarized screen. In this example, each of the users 310 and 320 may view only information of his or her own.

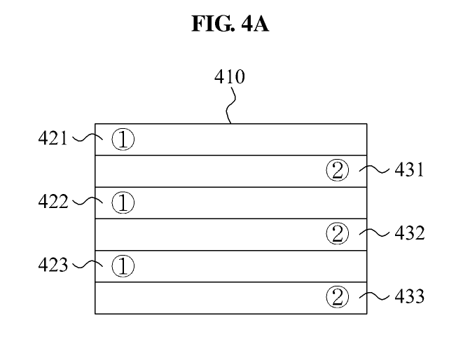

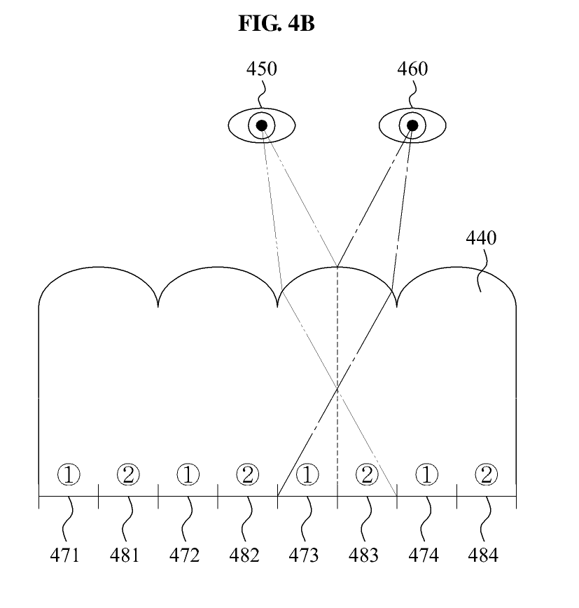

Hereinafter, an example of the display device 330 using a lenticular lens or a polarized screen will be described with reference to FIG. 4.

FIGS. 4A and 4B are views illustrating transparent display devices using a polarized screen and a lenticular lens, respectively, according to an embodiment.

FIG. 4A illustrates a display device 410 using a polarized screen.

The display device 410 may divide a screen into a plurality of areas 421, 422, 423, 431, 432, and 433. The display device 410 may control information for a first user to be displayed in areas 421, 422, and 423 included in a first group, and control information for a second user to be displayed in areas 431, 432, and 433 included in a second group, among the divided areas 421, 422, 423, 431, 432, and 433.

The display device 410 may provide first information displayed in the areas 421, 422, and 423 included in the first group to the first user using a polarizing filter. In this example, the first user may block second information, and view only the first information using polarized glasses. Further, the display device 410 may provide the second information displayed in the areas 431, 432, and 433 included in the second group to the second user. In this example, the second user may block the first information, and view only the second information using polarized glasses.

FIG. 4B illustrates a display device using a lenticular lens 440.

The display device may classify pixels 471, 472, 473, 474, 481, 482, 483, and 484 of the display device into pixels 471, 472, 473, and 474 included in a first area, and pixels 481, 482, 483, and 484 included in a second area. In this example, the pixels 471, 472, 473, and 474 included in the first area may display first information, and the pixels 481, 482, 483, and 484 included in the second area may display second information.

When a first user 460 views the display device adopting the lenticular lens 440, a gaze of the first user 460 may be refracted by the lenticular lens 440. Thus, the first user 460 may view only the pixels 471, 472, 473, and 474 included in the first area, among the plurality of pixels 471, 472, 473, 474, 481, 482, 483, and 484. Further, a gaze of a second user 450 may be refracted by the lenticular lens 440. Thus, the second user 450 may view only the pixels 481, 482, 483, and 484 included in the second area, among the plurality of pixels 471, 472, 473, 474, 481, 482, 483, and 484.

According to the embodiments shown in FIGS. 4A and 4B, although a display device displays first information and second information in the same area, a first user and a second user may selectively view only information of his or her own.

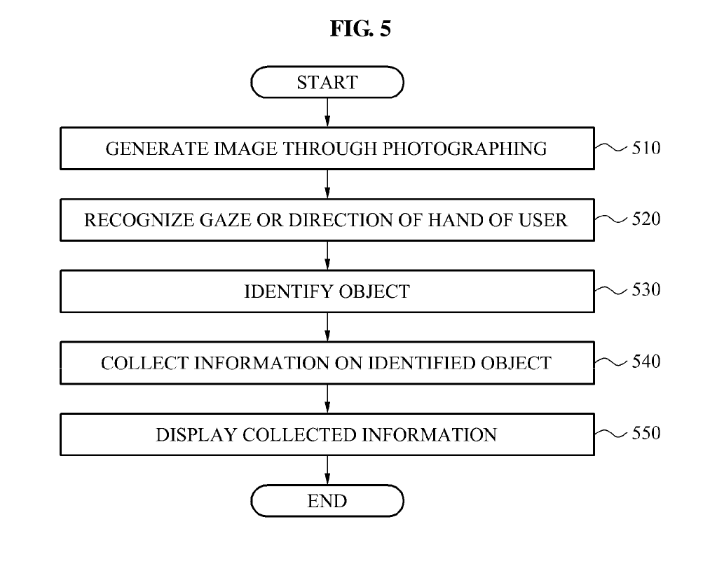

FIG. 5 is a flowchart illustrating a method of displaying an augmented reality according to an embodiment.

In operation 510, an apparatus for displaying an augmented reality may generate an image by photographing a user.

In operation 520, the apparatus for displaying an augmented reality may recognize a gaze of the user or a direction of a hand of the user positioned in a direction of a first plane of a transparent display device provided in a form of a flat plate. In this example, the user may view an object positioned on the other side, for example, in a direction of a second plane, of the transparent display device, or indicate the object with the hand.

In operation 520, the apparatus for displaying an augmented reality may recognize the gaze of the user or the direction of the hand of the user by analyzing the image generated in operation 510.

In operation 530, the apparatus for displaying an augmented reality may identify the object positioned in the direction of the second plane of the transparent display device, the object corresponding to the gaze of the user or the direction of the hand of the user.

In operation 540, the apparatus for displaying an augmented reality may collect information on the identified object. In operation 540, the apparatus for displaying an augmented reality may collect the information by referring to information on the recognized user. The apparatus for displaying an augmented reality may recognize the user by analyzing the image generated in operation 510.

In operation 550, the apparatus for displaying an augmented reality may display the collected information on the display device.

In operation 550, the apparatus for displaying an augmented reality may display the information at a point at which a straight line connecting the identified object and the gaze of the user intersects the transparent display device. The apparatus for displaying an augmented reality may display the information at a point at which a straight line connecting the identified object and the direction of the hand of the user intersects the transparent display device.

When a plurality of users view different objects respectively, gazes of the respective users and the transparent display device may overlap in the same area. In this example, the apparatus for displaying an augmented reality may display items of information on the respective objects in the same area.

The display device may display first information for a first user and second information for a second user in the same area using a lenticular lens or a polarized screen.

The methods according to the embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for displaying an augmented reality, the apparatus comprising:
a recognizer configured to recognize a gaze of a user or a direction of a hand of the user positioned in a direction of a first plane of a transparent display device provided in a form of a flat plate;
an object identifier configured to identify an object positioned in a direction of a second plane of the transparent display device, the object corresponding to the gaze of the user or the direction of the hand of the user;
an information collector configured to collect information on the identified object; and
a display unit configured to display the collected information on the display device.

2. The apparatus of claim 1, further comprising:
a camera unit configured to generate an image by photographing the user,
wherein the recognizer is configured to recognize the gaze of the user or the direction of the hand of the user by analyzing the generated image.

3. The apparatus of claim 2, wherein the recognizer is configured to recognize the user by analyzing the generated image, and
the information collector is configured to collect the information by referring to information on the recognized user.

4. The apparatus of claim 1, wherein the display unit is configured to display the collected information at a point at which a straight line connecting the object and the gaze of the user intersects the transparent display device, or
to display the collected information at a point at which a straight line connecting the object and the direction of the hand of the user intersects the transparent display device.

5. The apparatus of claim 1, wherein the display device is configured to display second information for a second user in an area in which the information is displayed.

6. The apparatus of claim 5, wherein the display device is configured to display the information and the second information in the same area using a lenticular lens or a polarized screen.

7. A method of displaying an augmented reality, the method comprising:
recognizing a gaze of a user or a direction of a hand of the user positioned in a direction of a first plane of a transparent display device provided in a form of a flat plate;
identifying an object positioned in a direction of a second plane of the transparent display device, the object corresponding to the gaze of the user or the direction of the hand of the user;
collecting information on the identified object; and
displaying the collected information on the display device.

8. The method of claim 7, further comprising:
generating an image by photographing the user,
wherein the recognizing comprises recognizing the gaze of the user or the direction of the hand of the user by analyzing the generated image.

9. The method of claim 8, wherein the recognizing comprises recognizing the user by analyzing the generated image, and
the collecting comprises collecting the information by referring to information on the recognized user.

10. The method of claim 7, wherein the displaying comprises displaying the collected information at a point at which a straight line connecting the object and the gaze of the user intersects the transparent display device, or
displaying the collected information at a point at which a straight line connecting the object and the direction of the hand of the user intersects the transparent display device.

11. The method of claim 7, wherein the displaying comprises displaying second information for a second user in an area in which the information is displayed.

12. The method of claim 11, wherein the display device is configured to display the information and the second information in the same area using a lenticular lens or a polarized screen.

13. A non-transitory computer-readable medium comprising a program for instructing a computer to perform the method of claim 7.
